(19) United States
(12) Patent Application Publication
(10) Pub. No.: US 2013/0036155 A1
(43) Pub. Date: Feb. 7, 2013

(54) DIGITAL MEDIA SHARING SYSTEM IN A DISTRIBUTED DATA STORAGE ARCHITECTURE

(71) Applicant: EXANETWORKS, INC., Portland, OR (US)

(72) Inventors: Michael Shaw, Portland, OR (US); Patrick Serex, Vesenaz, Geneva (CH)

(73) Assignee: EXANETWORKS, INC., Portland, OR (US)

(21) Appl. No.: 13/645,272

(22) Filed: Oct. 4, 2012

Related U.S. Application Data
(63) Continuation of application No. 12/703,621, filed on Feb. 10, 2010, now abandoned.
(60) Provisional application No. 61/152,186, filed on Feb. 12, 2009.

(51) Int. Cl. G06F 15/16

(52) U.S. Cl. 709/202; 709/203

(57) ABSTRACT

At least certain embodiments of the invention disclose a digital media sharing system for providing online album hosting services including receiving, at a web-album server, low-resolution versions of digital images from a client over a network instead of full-resolution versions of the digital images, wherein the full-resolution versions of the digital images remain stored locally at the client and storing the low-resolution versions of digital images at the web-album server instead of storing full-resolution images.

### CROSS-REFERENCE TO RELATED APPLICATIONS

This application is a continuation of U.S. application Ser. No. 12/703,621, filed Feb. 10, 2010, which claims the benefit of U.S. provisional application No. 61/152,186, filed Feb. 12, 2009, entitled “DIGITAL MEDIA SHARING SYSTEM IN A DISTRIBUTED DATA STORAGE ARCHITECTURE”, and which are herby incorporated by reference in their entirety.

### FIELD OF THE INVENTION

At least certain embodiments of the invention relate generally to data processing systems, and more particularly, but not exclusively, to processing media data over a network.

### BACKGROUND OF THE INVENTION

The advent of digital cameras changed the photography landscape quite dramatically. Instead of bringing an exposed film role to a photofinishing lab to obtain paper copies of the pictures taken, digital camera owners tend to share the digital media itself, mainly in the form of electronically mailed (email) image files, and/or print the pictures at home on a photo-quality personal printer. A certain segment of PC users also order prints online from services such as Shutterfly® or bring their storage media (memory card, CD . . . ) to a local photofinishing lab or kiosk for printing. These services offer a way to store and share digital pictures online in so-called “web-albums,” where users typically create an account, upload their picture files to a shared folder on the web, and then email the address of the album to a person or persons they want to share their pictures with. The album owner and the persons invited to view the album usually can order paper copies directly from the website. This approach has a number of advantages over email as users need to upload the pictures only once to share with multiple recipients over an extended period of time. Additionally, the recipients usually get a shorter email with a standard greeting from the sender and the address (in the form of a URL) of the online album, instead of a flood of pictures filling up their email account. The ability to order prints online directly from the web-album is convenient and creates new business opportunities for these album hosting services. Existing web-album solutions store the users full-resolution original image files on server-based storage systems and then render thumbnail-size preview pictures that are presented to the album viewers. When a viewer clicks on a thumbnail to see a larger picture, the web-album server typically renders a medium-sized image on the fly from the original picture file and presents it to the viewer. When a print is ordered, the server-based system electronically sends the full-resolution original picture to an affiliated print service.

While the shared electronic album model is convenient for end-users, it creates a serious challenge for online web-album hosting companies as it places high demands in terms of storage needs and network bandwidth requirements with associated high operational costs. Moreover, shared electronic album model is very slow for end-users because of the time necessary to upload full-size images. With digital photography there is practically no cost for a user to take additional digital pictures. As a consequence, a lot more digital photos are taken; however, a very small percentage of these digital photos are actually printed. Since the business of photo sharing has been driven in large part by the number of prints ordered, online album hosting services have encountered major difficulties in building a viable business due to the small percentage of prints ordered in comparison to the large number of pictures taken. Typically, users of online album hosting services store their digital images on the servers owned by the online album hosting services. As a result, these album hosting services may end up storing terabytes of digital images in huge data-class servers in hopes of getting a few print orders. This centralized photo album infrastructure has been manageable when the service is small to mid-size. However, when the business reaches a mature size, the number of hard disks, bandwidth needs, and the maintenance required for storing this vast amount of digital images generates excessive operating costs. In some cases businesses may need to utilize advertising revenue to offset these high operating costs, examples of which include the photo sharing web sites of Google® and Yahoo®. However, many customers find these online advertisements obtrusive.

### SUMMARY OF THE DESCRIPTION

At least certain embodiments of the invention disclose a digital media sharing system for providing online album hosting services including receiving, at a web-album server, low-resolution versions of digital media files from a client over a network instead of full-resolution versions of the digital media files, wherein the full-resolution versions of the digital media files remain stored locally at the client and storing the low-resolution versions of digital media files at the web-album server instead of storing full-resolution images.

### BRIEF DESCRIPTION OF THE DRAWINGS

A better understanding of at least certain embodiments of the invention can be obtained from the detailed description in conjunction with the following drawings, in which:

FIG. 1 illustrates an exemplary data processing system upon which the methods and apparatuses of the invention may be implemented.

### DETAILED DESCRIPTION

Throughout the description, for the purposes of explanation, numerous specific details are set forth in order to provide a thorough understanding of the present invention. It will be apparent to one skilled in the art, however, that the present invention may be practiced without some of these specific details. In other instances, well-known structures and devices are shown in block diagram form to avoid obscuring the underlying principles of embodiments of the invention.

### I. Bandwidth Efficient Digital Media Sharing System

At least certain embodiments disclose systems, methods and computer-readable media for digital media sharing in a distributed data storage architecture. This web-based digital media sharing and printing solution offers all the convenience and functions of existing online web-album solutions for end users without the disadvantages for the web-album hosting companies. In the example where the digital media includes digital images, instead of storing full-resolution digital images directly on a photo sharing server (referred to herein as a web-album server), at least certain embodiments of the digital media sharing system store only small-size, low-resolution versions of the original digital images which, while suitable for online viewing, occupy a fraction of the space that would be required by storing the original full-resolution images at the web-album server (conservatively on the order of 1/20th). This guarantees much lower storage and bandwidth requirements since the corresponding full-resolution images are only stored and transferred as needed. In one embodiment, the low-resolution versions of the digital images include thumbnails of the digital images. Viewers may utilize this web-based service provided with the digital media sharing system to order prints of desired photos within the online album. When a print is ordered, the server-based digital media sharing system gathers the needed digital images directly from the originator of the album (known as the publisher) using an agent application (such as a daemon) running in the background on the publisher's personal computer (PC). The web-album server then requests the appropriately scaled image based on the requirements for that print order and then caches the higher-resolution images for an arbitrary amount of time (typically indefinitely) until one or more print orders are filled, allowing quick processing in case an image is requested more than once. The higher-resolution images are then simply deleted from the web-album server, reclaiming the storage space, if necessary. In addition, the system can be configured and deployed in such a way that the agent application running on the publisher's PC transfers the higher-resolution images directly to a photofinishing lab, bypassing the web-album server altogether further reducing its bandwidth requirements. From the end-user perspective, sharing pictures using these embodiments is more convenient as only a fraction of the data is transferred up front making the digital media sharing process much quicker than existing solutions. In another embodiment, the agent can upload the full-resolution image to a central server for long-term, secure storage for archival purposes. While embodiments disclosed herein offer very attractive digital media sharing solutions including extremely fast uploading, convenient online print ordering, and simple-to-use web viewing, for operators these embodiments provide the very lowest in storage and network bandwidth costs.

In at least certain embodiments, the publisher creates an online album using digital images stored on the publisher's PC. In order to do so embodiments provide an agent application provided for use with the digital media sharing system. The agent application (agent) allows the publisher to create an online album. The agent may be implemented in hardware, software, or firmware or any combination thereof. If the agent is implemented in software, the agent may either be provided on a computer-readable medium such as a CD or floppy disk, or as a web-based service. The publisher creates an online digital media sharing album by selecting full-resolution digital images stored on the publisher's PC to the online album using a publishing interface included in the agent application. Whenever the publisher creates an online album using the publishing interface, the agent creates small-size, low-resolution versions of the full-resolution digital images and then uploads them to a web-album server of the digital media sharing system instead of uploading the full-resolution images themselves. The full-resolution digital images remain stored on the publisher's PC. In this manner, the vast amount of storage of the digital image data is distributed across multiple PCs corresponding to multiple publishers rather than at a centralized storage server. Thus, the digital media sharing system described herein is referred to as a distributed data storage digital media sharing system where the full-resolution digital images are stored on each publisher's PC and only the reduced-resolution version corresponding to each full-resolution digital image is stored centrally at one or more load-balanced web-album servers.

In at least one embodiment, the small-size, low-resolution versions of the full-resolution digital images include thumbnail versions of the full-resolution digital images. The web-album server receives and stores these small-size, low-resolution images as an album in an image database server coupled with the web-album server. In other embodiments, transferring and storing low-resolution versions of the digital images at the web-album server may also include transferring and storing an additional preview-size images corresponding to the thumbnails. The preview-size images may vary in size depending on the preferences of the publisher or system configuration.

The online digital media album may then be shared with others by the publisher via the web-album server. To do so, the publisher enters the email addresses of intended recipients with whom the publisher wishes to share the online album with into a graphical user interface (GUI) provided with the publisher application. The publisher then transfers the email addresses of the recipients of the shared online album to the web-album server. In response, the web-album server may send a message that includes a uniform resource locator (URL) of the online album to the intended recipients, referred to herein as the viewers, via an email message. The viewers of the online album may click on the URL in the email and view the online album in their own web browser. In one embodiment, the URL is a “long URL” representing a globally-unique hyperlink. This unique URL hyperlink is so long that it cannot be realistically discovered by hackers or other persons using a random URL generator or otherwise. Alternatively, the publisher may email the album straight to the intended viewers without going through the web-album server. This is referred to as the public mode. Other embodiments include a community mode where the viewers with whom a particular publisher wishes to share his or her online photos are already chosen by the publisher and each has his or her own account with an accompanying username and password. Each time a publisher creates or updates an album, the publisher's chosen viewers are automatically notified via email and can view the album by supplying the correct credentials.

Any web browser may be used by the viewer(s) as no specific application is needed for viewing. In one embodiment, the viewer may further share the online album with additional recipients. In this case, the above process is repeated for each additional viewer. The viewer simply enters the email addresses of the additional recipients into their web browser and the digital media sharing system transfers these addresses to the web-album server, which in turn sends additional URLs to the additional recipients via email messages. The additional viewers may then click on the URL in the email, view the album, and further share the album with other recipients. Prints may then be ordered by any viewers of the online album using the digital media sharing system described herein. Conversely, by using the community mode, the publisher may choose to limit the viewers who can you share a particular album. That is, a publisher may allow a viewer to view an album, but not allow that viewer to further share the album with additional viewers.

This process guarantees much lower storage and bandwidth requirements as full-resolution images are only transferred and stored as needed. In alternate embodiments, the digital media sharing system can be configured in such a way that the agent sends the full-resolution digital images directly to a photofinishing lab bypassing the web-album server altogether further reducing its network bandwidth requirements. Sharing digital images using the digital media sharing system described herein is more convenient as only a fraction of the data is transferred up front making the sharing process much quicker than existing centralized solutions. For example, storing 25 digital images (at 2 MB each) using a centralized solution of the prior art requires approximately 53 minutes of upload time at 128 kilobytes per second, whereas the decentralized digital media sharing system described herein requires only 50 seconds. This results in an upload time of roughly 50 times faster. Additionally, the storage requirements at the web-album server are drastically reduced due to the decentralized architecture. The digital media sharing system described herein is a distributed storage system where the full-resolution digital images are stored locally at each publisher's PC with the web-album server acting as a cache to store only the reduced-resolution versions of the full-resolution images. This distributed arrangement is highly scalable and is 30 to 40 times less costly than the centralized methods of the prior art. In addition, a photofinishing lab may distribute the digital media sharing agent application as a software package to each publisher. The digital media sharing agent application software may be in the form of a computer-readable medium such is a CD or floppy disk, or web-based application.

In certain embodiments, the digital media sharing process described herein is driven by the web-album server instead of the agent running locally on the publisher's PC. The publishing agent includes an uploader module to upload the thumbnails created by the agent from the full-resolution images stored at the publisher's PC. The uploader module acts as a slave of the web-album server. The uploader module may be a permanent program (such as a daemon) that runs all the time. The uploader transfers the thumbnail images to the web-album server under the direction of the web-album server. The decision as to what size and/or resolution of image is transferred by the uploader to the web-album server is dictated by the server itself. When uploading a brand new album, for example, the current rules for that album or for a given provider of photo sharing are dictated by the web-album server. In this way, the uploader module will be the same from agent to agent because each uploader module is unconcerned with the size and/or resolution at which it transfers the digital images to the web-album server. The uploader merely waits to receive the appropriate sizes and/or resolutions of the images from the server. That is, embodiments provide that dimensions of the thumbnails or other reduced-resolution digital images to be transferred from the uploader to the server need not be dictated by the uploader or by the publisher, but by the web-album server.

Whenever a new album is created, the web-album server receives an indication from the agent that a new album is ready for publishing and directs the uploader to transfer the thumbnail images at a certain size and/or resolution. This is advantageous because the web-album server can be adjusted to compensate for the dimensions required by the end-user. The dimensions required by end-user may vary substantially. For example, the end-user may be a viewer with a certain screen resolution and/or a photofinishing lab using a printer that requires certain dimensions. The web-album server has access to this information and can be adjusted without requiring adjustment to each of the thousands of agents associated with a particular web-album server in the distributed digital media sharing system. If a particular viewer orders a print or a screensaver, the web-album server directs the uploader to transfer the digital images at the appropriate resolution for the needs of that viewer. This is further advantageous because the full-resolution image stored at the publisher's PC may never have to be transferred to the web-album server depending on the requirements of the end-user (viewer or photofinishing lab). For example, in the case where the end-user requires a resolution “X” which is less than the resolution “Y” of a particular digital image stored on the publisher's PC, only the resolution “X” need be transferred to the web-album server. This not only decreases the network bandwidth required to transfer the digital image from the agent to the server, but also decreases the storage capacity required by the server to store the particular digital image. This further reduces the costs associated with providing online album hosting services. In addition to scaling the publishing agent can crop or add white borders if the source aspect ratio does match the target aspect ratio. For example, many digital cameras render pictures with 3:2 or 16:9 aspect ratios, but printers typically require different aspect ratios, depending on the print size.

A hint may be supplied regarding the intended use of the image or thumbnail, for example, to indicate if the image is intended for printing or screen viewing. This way the publishing agent can select the most appropriate rendering technique while producing the images to be uploaded. The web-album server will take care of all computations regarding the paper-fitting options in order to take advantage of variable-linked paper, if available from the printing service, and to handle mismatched aspect ratios between the image and the paper. The rendering part of the publishing agent will get two sets of coordinates: the first set will represent the source rectangle in image coordinates (the area of the image to consider) and the second set will represent the dimensions at which the source rectangle must be rendered to. When the image aspect's ratio matches the target image ratio, the source rectangle will equal the image dimensions. This arrangement will also accommodate cropping and zooming without special treatment by a renderer associated with the publishing agent. For example, the web-album server may ask for a 64×48 thumbnail and a 512×384 preview image at the same time, or it may ask for a 64×48 for screen and a 1200×900 for print. As a result, the agent renderer should be ready to produce any number of different target images upon request by the web-album server.

At least certain embodiments also provide enhanced security features. The first layer of security lies in the transmission mechanics employed by the digital media sharing system described herein. The basic architecture is based on a distributed model, with thousands of agents communicating with a few, load-balanced servers. Each publisher who creates an online album uses the agent which runs as a background service on any Windows or Macintosh-based PCs. When a user publishes an image, the agent generates a globally-unique identifier herein referred to as a “moniker” for the image along with a hash code for the image. The hash code may be generated by performing any of the known hash functions such as SHA-1 on the data corresponding to the digital image to output a unique hash value. The moniker and the hash code are transferred to the web-album server as a pending upload request. Afterwards and periodically thereafter, the agent contacts the server to determine if any job requests are pending for that agent. At no time does the server ever contact the agent. Additionally, at no time does the server have any ability to ask for a specific file on a publisher's PC. When the agent contacts the server to see if any upload requests are pending, the web-album server responds with that same moniker along with the hash code. The agent verifies these codes with its version of the image and if they match, the upload command is processed. In this way, all communications are initiated from the agent to the web-album server and not vice versa. Further, whenever an album is created, the digital media sharing system described herein will name each digital image in the album, but this name is never the name of the file originally on the publisher's PC. The mapping from the digital image on the publisher's PC to the name of the digital image in the online album is known by the publishing agent only. In one embodiment, this mapping is determined by matching the moniker in the hash code associated with the digital image on the publisher's PC with the corresponding information associated with the digital image in the online album. So, the local file name of the digital image on the publisher's PC and the local file directory in which the digital image resides is not available to potential hackers or any of the recipients of the digital image in the online album. The agent includes a local database that includes information regarding this mapping.

If the local file name or directory corresponding to the digital image is changed at the publisher's PC, the agent will still be able to locate the digital image (so long as it still exists on the publisher's PC) by performing this mapping including matching the moniker and hash code of the digital image in the online album with the corresponding moniker and hash code of the digital image in the local directory on the publisher's PC. In one embodiment, the agent performs a search through the various directories of the publisher's PC to find the matching digital image. In this embodiment, the agent will first search the original location of the digital image in the local file directory. If the digital image is not found, the agent performs an ever-expanding search up to a certain amount of time in an attempt to locate the digital image on the publisher's PC. If the file cannot be located, it is probably due to the fact that the file no longer exists on the publisher's PC or the digital image has been modified so that the hash code no longer matches the hash code of the digital image stored at the web-album server. For example, the digital image may have been changed using some software programs such as Photoshop. Once the search times-out, the agent informs the server that it cannot find requested digital image. In alternative embodiments, a synchronizer may be implemented to periodically check for matches between the local digital images stored on the publisher's PC and the digital images of the online album stored at the web-album server. The synchronizer would check the moniker and the original hash code for every file to make sure they all match, and, if not, the synchronizer would automatically delete the file at the web-album server.

A second layer of security is the permissions tied to every online album and digital image. Albums and images can be share-inhibited, printing-inhibited, and even download-inhibited. Albums can be either public or private. Private albums can only be accessed by an authorized user—either the owner of the album or someone he or she has specifically granted access. Public albums can be password protected and are further obfuscated by a globally-unique long URL. As discussed above, in one embodiment the long URL includes a 32-character URL. Additionally, the digital media sharing system described herein stores user passwords in a strong cryptographic format, which cannot be extracted. In addition to strong encryption techniques, the digital media sharing system employs industry-standard safeguards to protect the service itself. For example, at the publisher's PC, the agent is signed using a 128-bit authentication code. Moreover, to thwart hackers, the service itself is distributed where different servers handle specific tasks including image servers, web-service servers, web-viewing servers, and image database servers. Each server is fire-walled and the image database servers are never accessible from the Internet. In summary, embodiments provide a formidable security system including industry-standard security, a proprietary transmission model, distributed architecture, asset-level permissions system, obfuscated URLs, and user-level authentication.

As discussed above, the agent is configured to ping the server (referred to here in as a visit to the server) and determine whether there are any pending requests to be serviced. The agent visits the server periodically. The period in which the agent visits the web-album server may be configured by the web-album server. For example the agent may be configured to visit the server every 10 minutes to determine whether there are any pending request to be serviced. If not, the agent may go to sleep and visit the server on the next 10-minute interval. Alternatively, the visit frequency may be determined by the web-server. This may be advantageous because there are thousands of agents corresponding to each load-balanced server. So, in order to optimize network bandwidth usage, the server may determine when each of the associated agents visits the server. For example, if the server has not received any visits from an agent for a period of time, the server may determine that the agent is off-line. In such a case, the server can adjust the frequency of visits from that particular agent to once every hour or so. On the other hand, if a certain publisher has recently published an album, the server can adjust the frequency of visits for that particular agent to every minute. An adaptive polling at server-specified intervals is used for this purpose. The uploader should visit the web-album server upon startup and will get the polling interval in reply data from the server. The polling interval may change at each visit to the server and be different for different servers.

The above is given by way of illustration and not a limitation as any digital media is contemplated within the teachings of this description. For example, a digital media sharing system described herein may be extended to a video sharing system or an audio sharing system. In the case of digital video media, the same concept applies. Here, a digital video may be represented by a thumbnail image of that video. Instead of uploading the entire digital video, embodiments upload only a short animated representation of the digital video such as GIF file. When a viewer receives an album containing the digital video, in at least certain embodiments the viewer will see a thumbnail image representing the digital video and whenever the viewer clicks on the thumbnail image, a short animated GIF representing the digital video is played back to the viewer. For example, the animated GIF of the digital video may be a short 15-second video running in a loop. As described above with respect to digital images, the viewer may choose to purchase the video or an online album including the video. Furthermore, the teachings of this description can apply to an audio sharing system based on the same platform and the same web service just by changing the publishing agent. In this case, an online album may be created by a publisher that wants to share a certain song or songs located on the publisher's PC. In so doing, the publisher may compress one or more audio files in and album to generate one or more MP3s of 15 or 20 seconds representing the audio files. Additionally the MP3s may be published in mono instead of stereo to further save network bandwidth and server-side storage requirements. When the recipient receives the online album, the recipient can click on a representative thumbnail to hear the short 15 or 20 seconds of MP3 audio representing the song or songs stored on the publisher's PC which the publisher wishes to share with the recipient. If the recipient decides to purchase the online album or any portion thereof, the media sharing system would be addressed to one or more suppliers or studios from which the recipient can place an order to purchase the original song or songs in the album. In this manner, embodiments are content-agnostic and apply to any digital media whether it includes digital images, sound or video or any combination thereof.

Additionally, at least certain embodiments include a mechanism that allows anyone to email an image or group of images directly to an online album. By selecting the appropriate online album option in the publisher application, the system can assign a unique email address to that online album. Anyone can then email pictures to that unique email address. In addition to email, mobile phone users can send picture messages, such as Multimedia Messaging Service (MMS), to this same unique email address. The web server intercepts these messages and automatically extracts the picture attachments, scales the images, and makes logical assignment of the image names based on the attachment name, and then inserts these images into the online album. One use for this embodiment would be to update a shared online album while on vacation so that friends and family at home can view images online from the trip as soon as pictures are taken.

In another embodiment, a mechanism exists that allows the publisher to archive selected photos in their original, full-resolution format to an archival storage system. The user selects photos and the agent transfers the images in their entirety to an online storage system. One practical application of this may be for disaster recovery in case of mishaps with the publisher's PC. In this as well as other embodiments, the agent can be configured to support a high-bandwidth and a low-bandwidth data transfer mode. In the low-bandwidth transfer mode, the agent uses a fraction of the user's available bandwidth to transfer images so that the agent's data transfers do not interfere with the user's ability to access other Internet resources. In high-bandwidth mode, the agent is configured to consume as much of the bandwidth as possible to transfer the images as fast as possible.

At least certain embodiments further include a mechanism in the agent to upload images from a given album in a manner that enhances the online viewing experience. This can be accomplished by threading the thumbnails with the larger preview image scaling and uploading sequence. The images are first processed and then uploaded in such a way that the viewer can quickly see a screen full of thumbnails and their larger preview images sizes, while the remaining images continue to process in sequence. This process of threading the thumbnails with the larger preview image scaling and uploading sequence can be done automatically by the agent based on the computing capabilities and the bandwidth available to the agent; with no user intervention required.

At least certain embodiments further include mechanisms to enable a rich set of social networking capabilities to be offered to both publishers and viewers of the online albums. Features exist in the system to allow the publishers and the viewers to add nested comments to images as well as albums. Images and albums can also be rated on a scale, such as a 5-point scale for example. Key social networking capabilities include the ability to create one or more user groups and subscribe albums to these user groups. When an album is changed or otherwise modified, the users can be automatically notified by email. In certain embodiments, user groups can be freely created, destroyed and edited by users. Other embodiments of the system allow the viewers to ban specific users from sharing albums with them. Viewers can also create buddies including other users with whom albums are frequently shared.

Additionally, mechanisms are provided to allow the arbitrary assignment of metadata to images, albums, and users. This metadata can be either simple text properties like a name, extended properties like a name/value pair (e.g., “rotation”=0), or other complex binary data. This information may allow extensions to the system for 3rd party development without having to access the core database system directly. Instead, 3rd party development and extensibility can be provided through the published API.

### II. Beetle Desktop Viewer

Additional embodiments include a “beetle viewer,” which is a very basic viewer present on every computer and normally works in a static mode: such as the wallpaper and screensaver feature of the Computer's operating system. Embodiments provide for using one or more of these built-in viewers in a “subscriber” mode where only appropriately authorized collections (albums) of digital images from a given publisher are displayed on the subscriber's desktop and only if the publisher of this collection is accepted by beetle viewer's subscriber. When the viewer has agreed to subscribe to the digital images, then images may be sent any time by a given publisher to the subscriber. In one embodiment, digital images sent by an authorized publisher will be automatically displayed as wallpaper and/or screensavers on the subscriber's PC cycled through in a managed sequence without any action required by the subscriber. The beetle viewer consists of a resident program (a version of the agent described above) that can receive digital images from publishers that have been accepted by a given beetle viewer. The desktop screen of the subscriber's PC becomes the receiving place to display these digital images. In one embodiment, the publisher may flag an album and email it to one or more subscribers of the beetle viewer. The email contains a link and informs the subscribers to click on the link to subscribe to the album sent by the publisher. When the subscribers click on the link, the album is automatically displayed on the subscribers' desktop using the wallpaper or screen saver viewer of the subscribers' PC. In another embodiment, the subscribers beetle viewer may be configured to receive the album on their wallpaper or screen saver viewer without any action taken by the subscribers whatsoever. In this embodiment, whenever an authorized publisher sends an album including one or more digital pictures to the subscribers, the album will automatically show up on the subscribers' wallpaper or screensaver viewer without any action taken by the subscribers. So, the digital pictures automatically launch on the subscribers' wallpaper and/or screensaver on the subscribers' desktop. This is given by way of illustration and not of limitation as any number of mechanisms can be utilized to launch the album on the subscribers' wallpaper and/or screen saver. For example, there might be a large flashing icon placed on the subscribers' desktop each time an album is received from an authorized publisher.

The management of the beetle viewer includes basic functions like: excepting or refusing to accept digital images received from a given publisher (e.g., by using the email address of the publisher); adding and/or removing digital images from the list of digital images that will be displayed (the default mode sequentially displays all digital images in a collection); managing the time of display; managing the entire time of the slideshow; setting one of the digital images as the new default permanent wallpaper image; and/or reverting to the original configuration (i.e., before the startup of the beetle viewer). In at least certain embodiments, the web-album server detects if the recipient of a beetle wallpaper album has the appropriate software and adjust the email template sent from the publisher accordingly. If the recipient of the beetle wallpaper album does not have the appropriate software, the email template may include a link to download the beetle desktop viewer application. In addition, users can remove and/or disable albums and digital images from their wallpaper collection at any time.

### III. Shopping Cart

At least certain embodiments include a shopping cart mechanism including two mechanisms for processing print orders through an integrated shopping cart. For convenience, these mechanisms are designated “external” and “internal.” Both processes share the same user interaction including visiting an online album, selecting images from multiple albums, choosing the quantities and products, and checking out securely using Secure Socket Layer (SSL). In addition, both mechanisms support anonymous image selection; however, valid user credentials are required for the final checkout process. The two methods differ on how print orders are actually processed on the back-end.

The external process interfaces with a printing service's application programming interface (API). In this embodiment, the digital media sharing system queries the selected print service to determine the correct product catalog. This is usually based on the user's locale and language. This limits the product choices for that order as well as determines the product catalog and pricing. After an order is placed, the system gathers the digital images in the background, and if successful, delivers the order via the print service's API to that print if a provider.

The internal mechanism is different in that the images and photos are never gathered. In this embodiment, it is assumed that the print service provider has access to the digital images and is merely processing order requests on behalf of the user. A typical example would be a professional photographer who shot a sporting event, but needs to have the images online for taking orders. The internal process uses an XML document to list the print partner, the event code and product catalog as well as a secure database to record the user's order. When an order is received, both the customer and the print partner receive email confirmations. The print partner can login to a secure website to access his or her orders and mark their status.

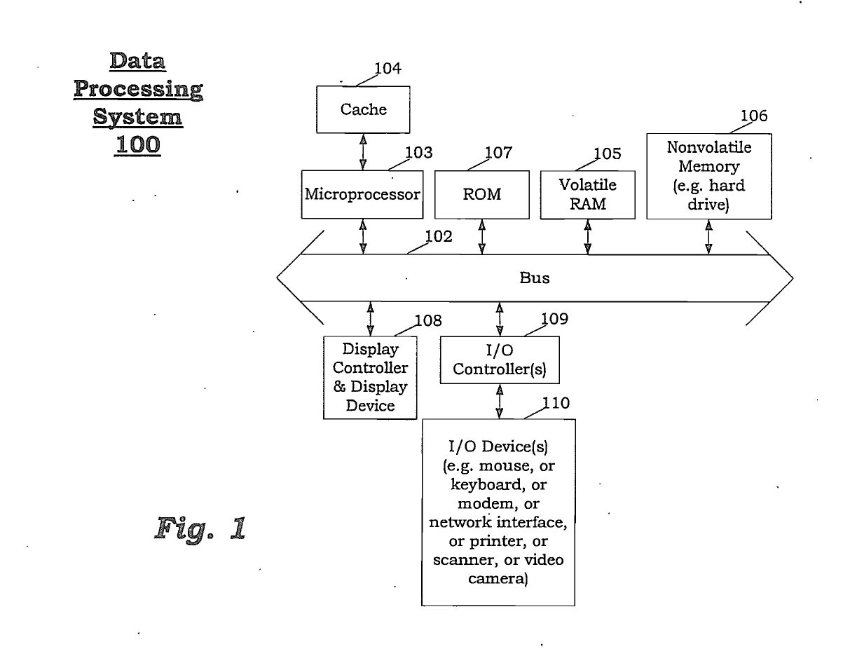

FIG. 1 illustrates an exemplary data processing system upon which the methods and apparatuses of the invention may be implemented. Note that while FIG. 1 illustrates various components of a data processing system, it is not intended to represent any particular architecture or manner of interconnecting the components as such details are not germane to the present invention. It will also be appreciated that network computers and other data processing systems which have fewer components or perhaps more components may also be used. The data processing system of FIG. 1 may, for example, be a workstation, or a personal computer (PC) running a Windows operating system, or an Apple Macintosh computer.

As shown in FIG. 1, the data processing system 101 includes a system bus 102 which is coupled to a microprocessor 103, a ROM 107, a volatile RAM 105, and a non-volatile memory 106. The microprocessor 103, which may be a processor designed to execute any instruction set, is coupled to cache memory 104 as shown in the example of FIG. 1. The system bus 102 interconnects these various components together and also interconnects components 103, 107, 105, and 106 to a display controller and display device 108, and to peripheral devices such as input/output (I/O) devices 110, such as keyboards, modems, network interfaces, printers, scanners, video cameras and other devices which are well known in the art. Typically, the I/O devices 110 are coupled to the system bus 102 through input/output controllers 109. The volatile RAM 105 is typically implemented as dynamic RAM (DRAM) which requires power continually in order to refresh or maintain the data in the memory. The non-volatile memory 106 is typically a magnetic hard drive or a magnetic optical drive or an optical drive or a DVD RAM or other type of memory systems which maintain data even after power is removed from the system. Typically, the non-volatile memory 106 will also be a random access memory although this is not required. While FIG. 1 shows that the non-volatile memory 106 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface (not shown). The system bus 102 may include one or more buses connected to each other through various bridges, controllers and/or adapters (not shown) as is well known in the art. In one embodiment the I/O controller 109 includes a USB (Universal Serial Bus) adapter for controlling USB peripherals, and/or an IEEE-1394 bus adapter for controlling IEEE-1394 peripherals.

It will be apparent from this description that aspects of the present invention may be embodied, at least in part, in software, hardware, firmware, or in combination thereof. That is, the techniques may be carried out in a computer system or other data processing system in response to its processor, such as a microprocessor, executing sequences of instructions contained in a memory, such as ROM 107, volatile RAM 105, non-volatile memory 106, cache 104, or a remote storage device (not shown). In various embodiments, hardwired circuitry may be used in combination with software instructions to implement the present invention. Thus, the techniques are not limited to any specific combination of hardware circuitry and software or to any particular source for the instructions executed by the data processing system 100. In addition, throughout this description, various functions and operations are described as being performed by or caused by software code to simplify description. However, those skilled in the art will recognize that what is meant by such expressions is that the functions result from execution of code by a processor, such as the microprocessor 103.

The invention also relates to apparatus for performing the operations herein. This apparatus may be specially constructed for the required purposes, or it may comprise a general purpose computer selectively activated or reconfigured by a computer program stored in the computer. Such a computer program may be stored or transferred in a computer-readable medium. A computer-readable medium can be used to store software and data which when executed by a data processing system, such as data processing system 100, causes the system to perform various methods of the present invention. This executable software and data may be stored in various places including for example ROM 107, volatile RAM 105, non-volatile memory 106, and/or cache 104 as shown in FIG. 1. Portions of this software and/or data may be stored in any one of these storage devices. A computer-readable medium may include any mechanism that provides (i.e., stores and/or transfers) information in a form accessible by a machine (e.g., a computer, network device, personal digital assistant, manufacturing tool, any device with a set of one or more processors, etc.). For example, a machine readable medium includes recordable/non-recordable media such as, but not limited to, a computer-readable storage medium (e.g., any type of disk including floppy disks, optical disks, CD-ROMs, and magnetic-optical disks, read-only memories (ROMs), random access memories (RAMs), EPROMs, EEPROMs, flash memory, magnetic or optical cards, or any type of media suitable for storing electronic instructions), or a computer-readable transmission medium such as, but not limited to, any type of electrical, optical, acoustical or other form of propagated signals (e.g., carrier waves, infrared signals, digital signals, etc.).

Additionally, it will be understood that the various embodiments described herein may be implemented with data processing systems which have more or fewer components than system 100. For example, such data processing systems may be a cellular telephone or a personal digital assistant (PDA) or an entertainment system or a media player (e.g., an iPod) or a consumer electronic device, etc., each of which can be used to implement one or more of the embodiments of the invention. The algorithms and displays presented herein are not inherently related to any particular computer system or other apparatus. Various general purpose systems may be used with programs in accordance with the teachings herein, or it may prove convenient to construct more specialized apparatuses to perform the method operations. The structure for a variety of these systems appears from the description above. In addition, the invention is not described with reference to any particular programming language. It will be appreciated that a variety of programming languages may be used to implement the teachings of the invention as described herein.

Throughout the foregoing specification, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. When a particular feature, structure, or characteristic is described in connection with an embodiment, it is submitted that it is within the knowledge of one skilled in the art to bring about such a feature, structure, or characteristic in connection with other embodiments whether or not explicitly described. Various changes may be made in the structure and embodiments shown herein without departing from the principles of the invention. Further, features of the embodiments shown in various figures may be employed in combination with embodiments shown in other figures.

In the description as set forth above and claims, the terms “coupled” and “connected,” along with their derivatives, may be used. It should be understood that these terms are not intended to be synonymous with each other. Rather, in particular embodiments, “connected” is used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some portions of the detailed description as set forth above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion as set forth above, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention may include various operations as set forth above or fewer operations or more operations or operations in an order which is different from the order described herein. The operations may be embodied in machine-executable instructions which cause a general-purpose or special-purpose processor to perform certain operations. Alternatively, these operations may be performed by specific hardware components that contain hardwired logic for performing the operations, or by any combination of programmed computer components and custom hardware components.

What is claimed is:

1. A digital image sharing method comprising:
providing online album hosting services including:
receiving, at a web-album server, low-resolution versions of digital images from a client over a network instead of full-resolution versions of the digital images, wherein the full-resolution versions of the digital images remain stored locally at the client; and
storing the low-resolution versions of digital images on a data storage server associated with the web-album server.

2. The digital image sharing method of claim 1, further comprising:
receiving from the client a request to share the digital images stored locally at the client and a list of one or more recipients with whom the digital images are to be shared; and
sending a notification to each of the one or more recipients including a link to access an online album for viewing the digital images.

3. The digital image sharing method of claim 2, wherein the link is a website Uniform Resource Locator (URL) of the online album.

4. The digital image sharing method of claim 2, further comprising:
receiving from the one or more recipients a request to further share the digital images stored locally at the client with additional recipients and a list of the additional recipients with whom the digital images are to be shared; and
sending a notification to each of the additional recipients including a link to access the online album for viewing the digital images.

5. The digital image sharing method of claim 4, wherein the list of one or more recipients and the list of additional recipients include a list of email addresses of each recipient.

6. The digital image sharing method of claim 2, further comprising transferring the online album including the low-resolution versions of the digital images to each recipient that clicks on the link to view the online album.

7. The digital image sharing method of claim 6, wherein the client initiates communications with the web-album server including making periodic visits to the web-album server to determine if there are any pending jobs to be processed.

8. The digital image sharing method of claim 7, further comprising:
receiving at the web-album server an order for at least one print of one or more of the digital images in the online album from a recipient;
on a next visit from the client, requesting the full-resolution versions of the one or more digital images from the client; and
receiving and temporarily storing in the data storage server associated with the web-album server the full-resolution versions of the one or more digital images for printing.

9. The digital image sharing method of claim 8, further comprising:
printing the full-resolution versions of the one or more digital images stored at the data storage server; and
sending full-resolution prints of the one or more digital images to the recipient.

10. The digital image sharing method of claim 9, further comprising deleting the full-resolution versions of the one or more digital images from the data storage server, reclaiming storage space.

11. A system comprising:
a client including:
a memory to store full-resolution versions of digital media files; and
a publishing agent module configured to transfer low-resolution versions of the digital media files to a server over a network; and
the server including:
a publishing interface configured to receive the low-resolution versions of digital media files from the client instead of full-resolution versions of the digital media files, wherein the full-resolution versions of the digital media files remain stored locally at the client; and
a digital media file database to store the low-resolution versions of the digital media files received from the client.

12. The system of claim 11, wherein the publishing interface is further configured to receive from the client a request to share the digital media files stored locally at the client and a list of one or more recipients with whom the digital media files are to be shared.

13. The system of claim 12, wherein the server further comprises:
an album generator to generate an online album for online viewing of the low-resolution versions of the digital media files; and
a viewer interface to send a message to the one or more recipients including a link to access an online album containing the digital media files.

14. The system of claim 13, wherein link is a website Uniform Resource Locator (URL) of the online album.

15. The system of claim 13, wherein the viewer interface is further configured to:
receive from the one or more recipients a request to further share the digital media files stored locally at the client and a list of additional recipients with whom the digital media files are to be shared; and
send a message to each of the additional recipients including a link to access the online album for viewing the digital media files.

16. The system of claim 15, wherein the viewer interface is further configured to transfer the online album including the low-resolution versions of the digital media files to each recipient that clicks on the link to view the online album.

17. The system of claim 16, wherein the client initiates communications with the server including making periodic visits to the server to determine if there are any pending jobs to be processed.

18. The system of claim 17, wherein the viewer interface is further configured to:
receive an order for at least one print of one or more of the digital media files in the online album from a recipient; and
on the next visit from the client, request the full-resolution versions of the one or more digital media files from the client.

19. The system of claim 18, wherein the publishing interface is further configured to receive and temporarily store in the digital media file database the full-resolution versions of the one or more digital media files for printing.

20. A method of digital media sharing comprising:
receiving, at an application running on a subscriber's PC, an album containing one or more digital media files to be shared from an authorized publisher;
automatically displaying, without action by the subscriber, the received album as wallpaper on a desktop of the subscriber's PC using a basic viewer built into an operating system of the subscribers PC.

21. The method of digital media sharing of claim 20, wherein the operating system is a Windows operating system and the basic viewer includes a wallpaper viewer.

22. The method of digital media sharing of claim 20, further comprising automatically cycling through the digital media files in the album in a managed sequence without action by the subscriber.

23. The method of digital media sharing of claim 22, further comprising:
receiving an email message containing an online link to the album from the publisher; and
clicking on the link to view the album on the subscriber's desktop.
